(19) United States
(12) Patent Application Publication
(10) Pub. No.: US 2004/0039584 A1
(43) Pub. Date: Feb. 26, 2004

(54) Method of selecting mask manufacturer of photomask

(75) Inventors: Masayoshi Mori, Hyogo (JP); Kunihiro Hosono, Hyogo (JP); Ichiro Arimoto, Hyogo (JP); Yuko Kikuta, Hyogo (JP)

Correspondence Address: LEYDIG VOIT & MAYER, LTD, 700 THIRTEENTH ST. NW, SUITE 300, WASHINGTON, DC, 20005-3960, US

(73) Assignee: Mitsubishi Denki Kabushiki Kaisha, Tokyo (JP)

(21) Appl. No.: 10/350,128

(22) Filed: Jan. 24, 2003

(30) Foreign Application Priority Data
Jul. 18, 2002 (JP) 2002-209520

(51) Int. Cl. G06F 17/50

(52) U.S. Cl. 705/1; 705/7

(57) ABSTRACT

A selecting method includes the steps of receiving pattern-forming area 100% region data and unit price data from a mask manufacturer's computer, extracting a 100% code that matches a condition based on the pattern-forming area 100% region data if data are received from computers of at least a predetermined number of mask manufacturers, calculating a pattern-forming area ratio based on a pattern-forming 100% region of the extracted 100% code and a pattern-forming region of the pattern-forming area data, calculating a unit price from a pattern-forming area ratio based on the unit price data and pattern-forming area ratio, and determining a mask manufacturer to which an order is sent based on the calculated unit price.

### BACKGROUND OF THE INVENTION

1. Field of the Invention

The present invention relates to a method employed in a semiconductor device ordering system for selecting an order receiver for a photomask used as an original of a wafer for a semiconductor device, and more particularly, to a selection method that allows reduction of a unit price of a photomask.

2. Description of the Background Art

Conventionally, IC (Integrated Circuit) chips including circuits, of which wiring patterns are changed in accordance with specifications requested by customers, have been manufactured by IC chip manufacturers (i.e., wafer manufacturers). Such an IC chip is manufactured using a photomask having a light shield pattern formed on a synthetic quartz substrate by a metal thin film, as an original, in the step of photolithography, i.e., one of the steps in manufacturing of the IC chip. Information relating to specifications is sent from an orderer, i.e. a wafer manufacturer, to an order receiver, i.e. a mask manufacturer, via a magnetic tape or the like storing the information, or online. The mask manufacturer prepares manufacturing data for manufacturing a photomask, based on the received information relating to the specifications. Order information such as a quantity of photomasks, delivery date and others are sent from the orderer, i.e. wafer manufacturer, to the order receiver, i.e. mask manufacturer, by telephone or online. Based on the order information, the mask manufacturer creates management data including information required for production management such as a priority, a product code, a shipping destination and a delivery date as well as information required for quality management. The created management data is sent to a photomask manufacturing line. The photomask manufacturing line manufactures a photomask based on the manufacturing data prepared based on the specifications and the management data created based on the order information. The photomask is produced by, for example, an electron beam exposure device controlled by the manufacturing data.

An example of such a method of producing a semiconductor device is disclosed in Japanese Patent Laying-Open No. 2002-41126. In the disclosed production method, an order for a semiconductor device is received by exchanging information between an intending order receiver and an intending orderer, to produce the semiconductor device. The production method includes the first step of urging the intending orderer to enter the specifications of the semiconductor device in response to a request from the intending orderer, the second step of producing a plurality of circuit patterns and calculating at least two design parameters for each circuit pattern, in consideration of the conditions in that charged particle beam exposure of a character projection method is used to transfer the patterns, based on the specifications of the semiconductor device selected by the intending orderer, and the third step of presenting the at least two design parameters for each circuit pattern to the intending orderer and urging the intending orderer to select a circuit pattern that satisfies a desired condition.

According to the production method in the disclosure above, the intending orderer who requests production of the semiconductor device can establish a direct connection with the intending order receiver in order to produce a circuit pattern of a desired device by simulation. Here, parameters such as device performance, a chip area, cost, limit of time, which are to be considered by the intending orderer in requesting of the production, are presented to the intending orderer for the orderer to make a selection. Thus, selection and ordering of a pattern that is the most suitable for the intending orderer can be realized, without any perception gap in device design that had conventionally occurred among a designer, a process technician and an intending orderer. More specifically, the method allows selection of a pattern that can be produced at a lower cost and within a shorter period, to make up for somewhat deteriorated device performance.

However, the disclosed production method above employs character projection, in which a circuit pattern is divided into small rectangular or triangle patterns and repeatedly subjected to exposure. This eliminates the need for a mask dedicated to a pattern exposure. Thus, application of the production method above to the ordering system of photomasks would have no effect.

In use of a photomask, the price of the mask is set in accordance with the running cost of a manufacturing device used, such as a pattern-forming device and a defect inspection device. The running cost is generally obtained by simply averaging the operating rate of a device. In this way, the price is always constant irrespective of the size of the chip area. In such a case, though a mask manufacturer may gain a margin benefit in accordance with the difference in the chip area, the price of the mask may, as a result, be increased.

### SUMMARY OF THE INVENTION

An object of the invention is to provide a mask manufacturer selecting method that allows determination of a manufacturer that can manufacture a photomask of a low price.

Another object of the invention is to provide a mask manufacturer selecting method that facilitates determination of a manufacturer that can manufacture a photomask of a low price.

A further object of the invention is to provide a mask manufacturer selecting method that allows accurate determination of a manufacturer that can manufacture a photomask of a low price.

According to one aspect of the present invention, a mask manufacturer selecting method selects one mask manufacturer from at least two mask manufacturers that manufacture photomasks used in manufacturing of a semiconductor wafer. The mask manufacturer selecting method includes the steps of storing a maximum area of a pattern formed on a photomask for each of the at least two mask manufacturers, storing a price paid by an orderer for manufacturing of the photomask in accordance with a ratio of the maximum area to an area of the pattern formed on the photomask, for each of the at least two mask manufacturers, storing order specification data including the area of the pattern of the photomask, calculating a pattern-forming ratio of the maximum area to an area of the pattern of the photomask included in the order specification data for each of the at least two mask manufacturers, calculating an estimated price for the order specification data based on the calculated pattern-forming ratio and a price stored in accordance with the stored ratio, for each of the at least two mask manufacturers, and selecting one mask manufacturer from the at least two mask manufacturers based on at least two of the estimated prices calculated for each of the at least two mask manufacturers.

According to the aspect described above, a pattern-forming ratio is calculated based on the maximum area of the mask pattern and the area of the photomask pattern included in the order specification data. Based on the pattern-forming ratio, a price stored in advance in accordance with the ratio is calculated. For instance, the price is set higher as the ratio increases, while it is set lower as the ratio decreases. Hence, an estimated price becomes lower as the area of the pattern to be actually ordered is reduced relative to the maximum area. Thus, a mask manufacturer can be selected by varying the estimated price based on the pattern-forming ratio of the photomask. As a result, a mask manufacturer selecting method can be provided that allows easy determination of a manufacturer that manufactures a photomask of a low price.

According to another aspect of the present invention, a mask manufacturer selecting method is to select one mask manufacturer from at least two mask manufacturers that manufacture photomasks used in manufacturing of a semiconductor wafer. The mask manufacturer selecting method includes the steps of storing a maximum area of a pattern formed on a photomask for each of the at least two mask manufacturers, storing order specification data including areas of a plurality of patterns for the photomask, calculating a pattern-forming ratio of the maximum area to an area of a pattern of a photomask included in the order specification data for each of the at least two mask manufacturers, creating synthesizable pattern information for a combination of the plurality of patterns such that the pattern-forming ratio of the combined patterns satisfies a predetermined condition, for each of at least two mask manufacturers, and selecting one mask manufacturer from the at least two mask manufacturers based on the synthesizable pattern information created for each of the at least two mask manufacturers.

According to the aspect described above, the pattern-forming ratio is calculated based on the maximum area of the mask pattern and the area of the photomask pattern included in the order specification data. For instance, synthesizable pattern information for a combination of a plurality of patterns is created such that the pattern-forming ratio does not far exceed 100%. If a plurality of patterns to which orders are actually sent can be combined at manufacturing, the estimated price can be lowered. Thus, patterns to be synthesized together are found based on the pattern-forming ratio of a photomask, in order to select a mask manufacturer. As a result, a mask manufacturer selecting method can be provided by which a manufacturer that manufactures a photomask of a low price can readily be determined.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 shows a whole structure of a mask manufacturer selecting system according to the first embodiment of the present invention;

FIG. 2 shows a pattern-forming area of a pattern formed on a photomask;

FIG. 3 shows an outer appearance of a computer realizing a server shown in FIG. 1;

FIG. 4 is a control block diagram of the computer shown in FIG. 3;

FIG. 5 illustrates pattern-forming area 100% region data sent from a mask manufacturer's computer according to the first embodiment of the invention;

FIG. 6 illustrates unit price data sent from a mask manufacturer's computer according to the first embodiment of the invention to a server and stored in the server;

FIG. 7 illustrates pattern-forming region data stored in the server according to the first embodiment of the present invention;

FIG. 8 is a flowchart showing a control structure of a program executed in the mask manufacturer selecting system according to the first embodiment of the present invention;

FIGS. 9 and 10 show a comparison table of estimated prices;

FIG. 11 is a flowchart showing a control structure of a program executed in the mask manufacturer selecting system according to a modification of the first embodiment of the present invention;

FIG. 12 shows a specification and use database for each of the photomask steps stored in the server according to the second embodiment of the present invention;

FIG. 13 shows a synthesizable photomask data stored in the server according to the second embodiment of the present invention; and

FIG. 14 is a flowchart showing a control structure of a program executed in the mask manufacturer selecting system according to the second embodiment of the present invention.

### DESCRIPTION OF THE PREFERRED EMBODIMENTS

Embodiments of the present invention will now be described with reference to the drawings. In the following description and drawings, the same parts are denoted by the same reference characters, and have the same names and functions. Therefore, detailed description thereof will not be repeated.

First Embodiment

Referring to FIG. 1, a mask manufacturer selecting system according to the present embodiment includes computers 200 of a plurality of mask manufacturers that manufacture photomasks, an order computer 300 for creating order data for a photomask and sending it to computer 200 of a mask manufacturer selected by a server 100, and server 100 connected to these computers over a network 500.

Server 100 stores order specification data including the pattern-forming area of a photomask. Mask manufacturer's computer 200 creates pattern-forming area 100% region data indicating the maximum pattern-forming area on a substrate where the photomask is formed, and stores the created data. Mask manufacturer's computer 200 creates unit price data of the photomask in accordance with the ratio of the pattern-forming area of the photomask to the maximum pattern-forming area. The pattern-forming area 100% region data and the unit price data of the photomask are created on a mask manufacturer basis.

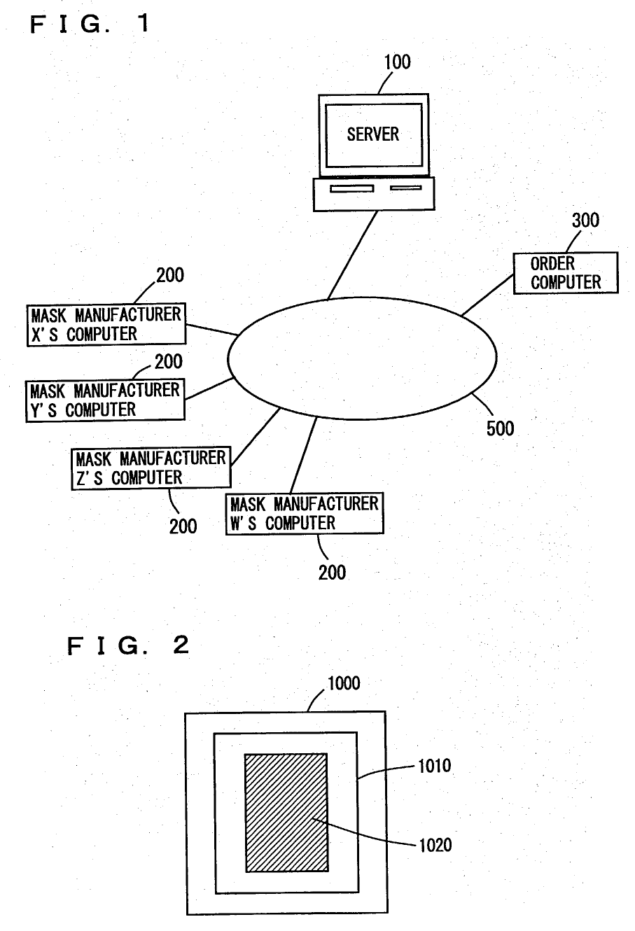

Referring to FIG. 2, a pattern-forming area 100% region is described. A pattern-forming area 100% region 1010 is set, which is determined by the size of a substrate and is corresponding to a preset value of the pattern-forming area. In practice, an actual pattern is formed in a pattern-forming region 1020 so as not to far exceed pattern-forming area 100% region 1010. Here, the pattern-forming area ratio is calculated by (the area of pattern-forming region 1020)/(the area of pattern-forming area 100% region 1010).

Server 100 stores the pattern-forming area 100% region data and the unit price data received from computers 200 of a plurality of mask manufacturers. Server 100 calculates the pattern-forming area ratio based on the pattern-forming region of a photomask included in the stored order specification data and the pattern-forming area 100% region data. Server 100 calculates the price of a photomask based on the calculated pattern-forming area ratio and the unit price data. Such a process is executed by each of the plurality of mask manufacturers, to calculate the prices corresponding to the plurality of mask manufacturers. Server 100 implements a mask manufacturer selecting function that selects a mask manufacturer to which an order is sent, based on the calculated price.

The mask manufacturer selecting function in server 100 of the mask manufacturer selecting system according to the present embodiment is implemented by a CPU (Central Processing Unit) in a computer executing a predetermined program.

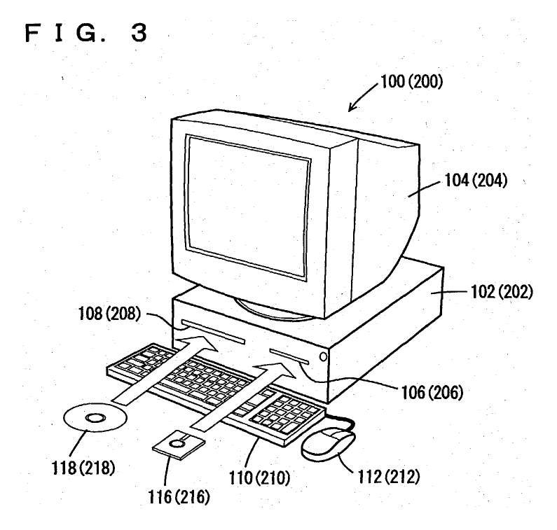

FIG. 3 shows an outer appearance of a computer system, which is an example of server 100 implementing the mask manufacturer selecting function. Referring to FIG. 3, the computer system includes a computer 102 provided with an FD (Flexible Disk) driving device 106 and a CD-ROM (Compact Disc-Read Only Memory) driving device 108, a monitor 104, a keyboard 110 and a mouse 112.

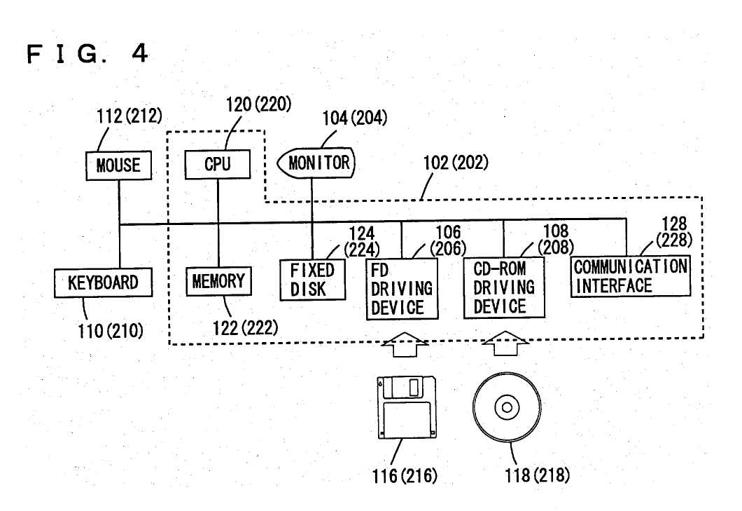

FIG. 4 is a block diagram showing the structure of the computer system. As shown in FIG. 4, computer 102 includes, in addition to FD driving device 106 and CD-ROM driving device 108 as described above, a CPU (Central Processing Unit) 120, a memory 122, a fixed disk 124 and a communication interface 128 for establishing communication with other computers, which are connected with one another via a bus. An FD 116 is mounted to FD driving device 106. A CD-ROM 118 is mounted to CD-ROM driving device 108. FD 116 and CD-ROM 118 each stores a predetermined program corresponding to a software.

As already described, server 100 having the mask manufacturer selecting function is implemented by a computer hardware and a software executed by CPU 120. Such a software is generally stored into a storage medium such as FD 116 and CD-ROM 118 as a program to be distributed, and is read from the recording medium by FD driving device 106, CD-ROM driving device 108 or the like, to be once stored into fixed disk 124. The software is further read from fixed disk 124 onto memory 122, and is executed by CPU 120.

The computer's hardware itself is a common one. The computer includes a control circuit including a CPU, a storage circuit, an input circuit, an output circuit and an OS (Operating System), and is provided with an environment in which a program is executed. The program of the present invention is to function such a computer as a mask manufacturer selecting device. The most essential part of the present invention is, therefore, realized by a program stored in a storage medium such an FD, a CD-ROM, a memory card or a fixed disk.

It is noted that the operation of the computer itself shown in FIGS. 3 and 4 is well known, so that detailed description thereof will not be repeated here.

Mask manufacturer's computer 200 shown in FIG. 1 also involves a common computer system. Thus, reference characters corresponding to the parts of mask manufacturer's computers 200 are indicated with parentheses in FIGS. 3 and 4.

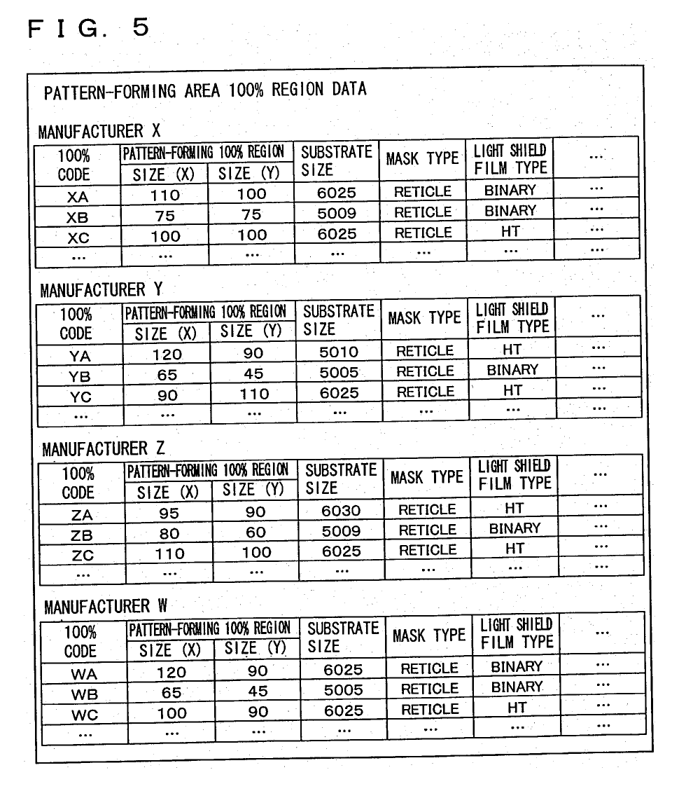

Referring to FIG. 5, the pattern-forming area 100% region data stored in fixed disk 124 of server 100 in the mask manufacturer selecting system according to the present embodiment is described. As shown in FIG. 5, the pattern-forming area 100% region data corresponds to the data received from a mask manufacturer X's computer 200, a mask manufacturer Y's computer 200, a mask manufacturer Z's computer 200 and a mask manufacturer W's computer 200 over network 500. As shown in FIG. 5, a 100% code, a 100% area (size (X), size (Y)), the size of a substrate, the type of a mask and the type of a light shield film are stored for each mask manufacturer.

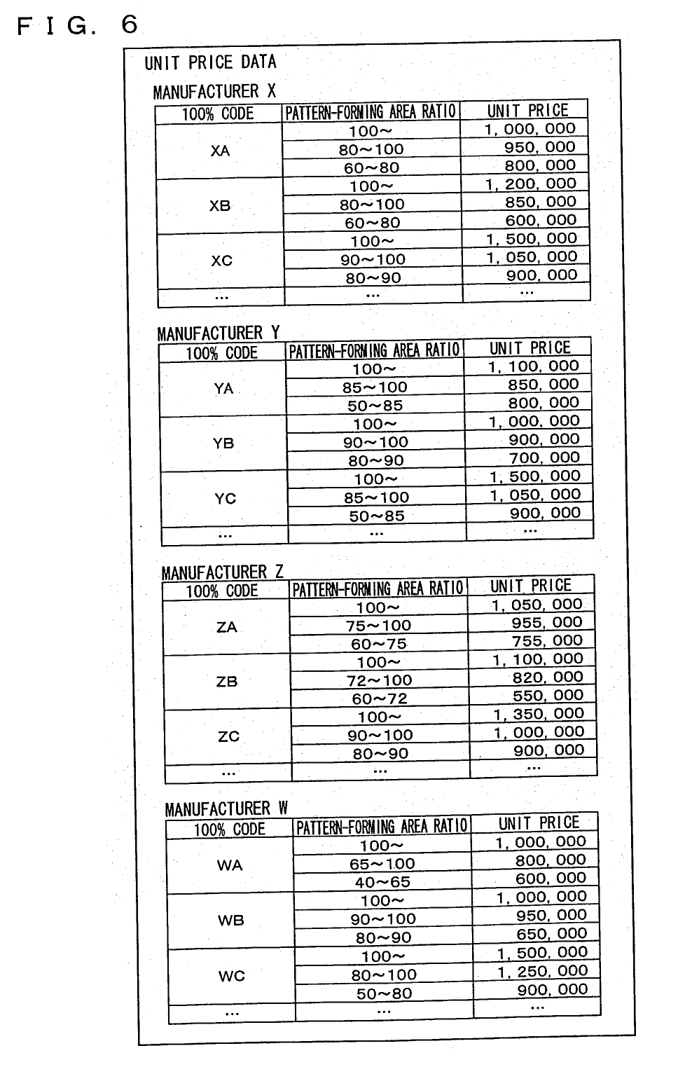

Referring to FIG. 6, the unit price data stored in fixed disk 120 of server 100 is described. As shown in FIG. 6, the unit price data also corresponds to data received from mask manufacturer X's computer 200, mask manufacturer Y's computer 200, mask manufacturer Z's computer 200, and mask manufacturer W's computer 200 over network 500. As shown in FIG. 6, a 100% code, a pattern-forming area ratio, and a price for each pattern-forming area ratio are stored for each mask manufacturer.

It is noted that the pattern-forming area 100% region data and unit price data shown in FIGS. 5 and 6 are created by a mask manufacturer and sent to server 100.

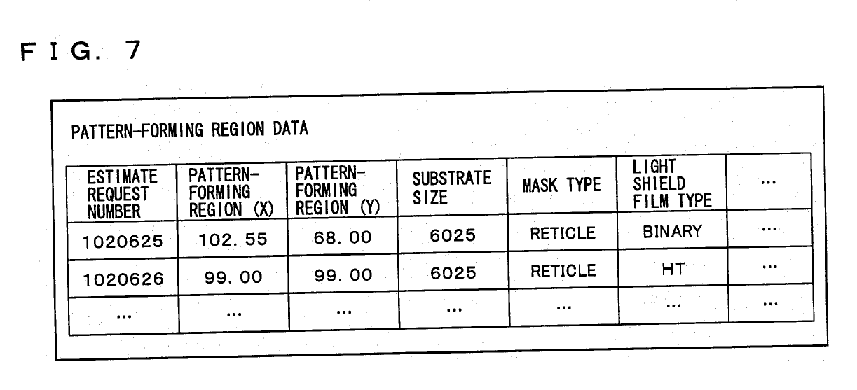

Referring to FIG. 7, the pattern-forming region data created at server 100 is described. As shown in FIG. 7, the pattern-forming region data includes an estimate request number, a pattern-forming region (X), a pattern-forming region (Y), the size of a substrate, the type of a mask and the type of a light shield film, for each photomask that receives a request for an estimate.

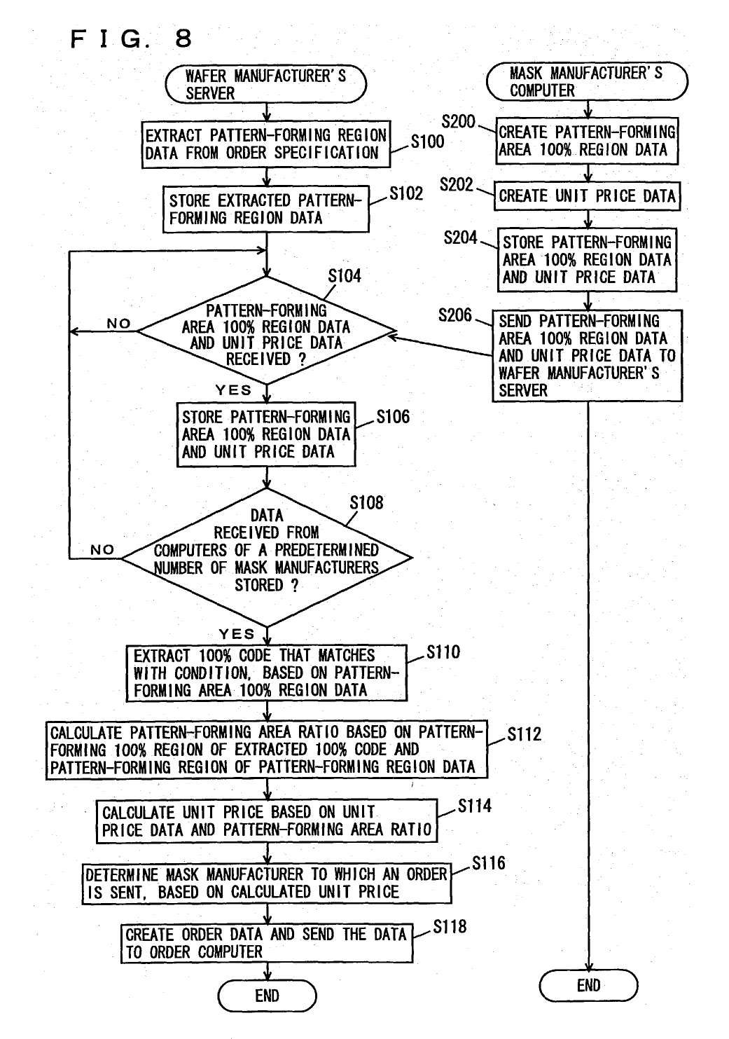

Referring to FIG. 8, a control structure of a program executed at wafer manufacturer's server 100 and at mask manufacturer's computer 200 in the mask manufacturer selecting system according to the present embodiment is described.

At step (hereinafter abbreviated as S) 100, CPU 120 in wafer manufacturer's server 100 extracts pattern-forming region data (FIG. 7) from an order specification. At S102, CPU 120 stores the extracted pattern-forming region data into fixed disk 120.

At S104, CPU 120 determines whether or not the pattern-forming area 100% region data and unit price data have been received from mask manufacturer's computer 200. If the pattern-forming area 100% region data and unit price data have been received (YES at S104), the process goes on to S106. If not (No at S104), the process goes back to S104, where CPU 120 waits for reception of the pattern-forming area 100% region data and unit price data from mask manufacturer's computer 200.

At S106, CPU 120 stores the pattern-forming area 100% region data and unit price data into fixed disk 120.

At S108, CPU 120 determines if the data transmitted by computers 200 of a predetermined number of mask manufacturers have been stored. If the data received from computers of a predetermined number of mask manufacturers have been stored (YES at S108), the process goes on to S110. If not (NO at S108), the process goes back to S104.

At S110, CPU 120 extracts a 100% code that matches a condition, based on the pattern-forming area 100% region data. At S112, CPU 120 calculates a pattern-forming area ratio based on the pattern-forming 100% region of the extracted 100% code and the pattern-forming region of the pattern-forming region data. At S114, CPU 120 calculates a unit price based on the unit price data and the pattern-forming area ratio.

At S116, CPU 120 determines a mask manufacturer to which an order is sent based on the calculated unit price. Here, a mask manufacturer having the lowest unit price is, for example, determined as the mask manufacturer to which the order is sent.

At S118, CPU 120 creates order data and transmits the data to order computer 300. Though it was described above that order data was transmitted to order computer 300 in the process at S118, it is not limited thereto. CPU 120 of server 100 may create order data and transmit the order data, for example, directly to mask manufacturer's computer 200.

At S200, CPU 220 of mask manufacturer's computer 200 creates pattern-forming area 100% region data (FIG. 5). At S202, CPU 220 creates unit price data (FIG. 6). At S204, CPU 220 stores the pattern-forming area 100% region data and unit price data into fixed disk 220. At S206, CPU 220 transmits the pattern-forming area 100% region data and unit price data to wafer manufacturer's server 100.

The operation of the mask manufacturer selecting system according to the present embodiment based on the above-described structure and flowchart will now be described.

In mask manufacturer's computer 200, an operator of a mask manufacturer creates pattern-forming area 100% region data (FIG. 5) and unit price data (FIG. 6). Here, in computer 200 of mask manufacturer X, the pattern-forming area 100% region data for manufacturer X shown in FIG. 5 and the unit price data for manufacturer X shown in FIG. 6 are created. The created pattern-forming area 100% region data and unit price data are transmitted to wafer manufacturer's server 100 (S206).

In wafer manufacturer's server 100, pattern-forming region data (FIG. 7) is extracted from an order specification (S100), and the extracted pattern-forming region data is stored into fixed disk 120 (S102).

If server 100 receives pattern-forming area 100% region data and price data from mask manufacturer's computer 200 (YES at S104), the pattern-forming area 100% region data and price data are stored into fixed disk 120 of server 100 (S106). Such an operation is repeatedly executed until data received from computers 200 of a predetermined number of mask manufacturers are stored.

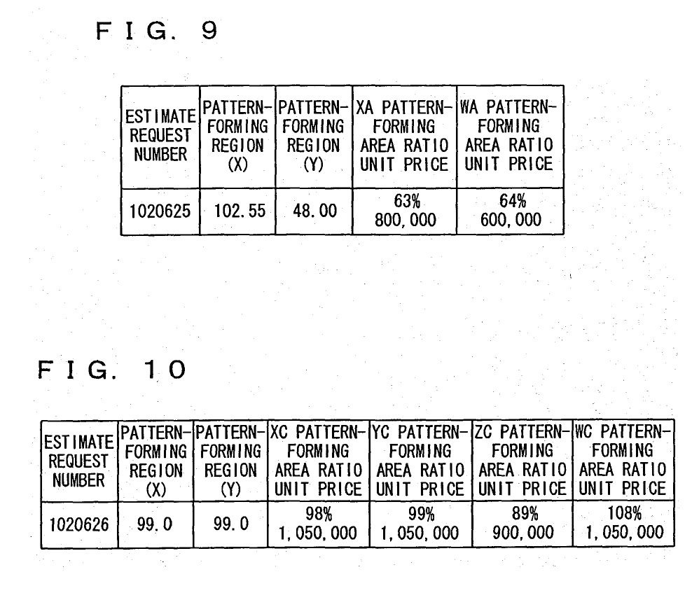

When the pattern-forming area 100% region data and unit price data are received from computers 200 of a predetermined number of mask manufacturers (YES at S108), a 100% code that matches a condition is extracted based on the pattern-forming area 100% region data (S110). Here, for a mask having an estimate request number of “1020625” in the pattern-forming region data shown in FIG. 7, the size of a substrate is “6025,” the type of a mask is “Reticle,” and the type of a light shield film is “Binary.” A mask in the pattern-forming area 100% region data received from each mask manufacturer shown in FIG. 5 is extracted that has a substrate size, a mask type and a light shield film type corresponding to the substrate size, the mask type and the light shield film type above. As a result, as shown in FIG. 9, two masks with a 100% code of “XA” from manufacturer X and with a 100% code of “WA” from manufacturer W match with the estimate request number of “1020625.”

The pattern-forming area ratio is calculated based on the pattern-forming 100% region of the extracted 100% code and the pattern-forming region of the pattern-forming region data (S112). Here, as shown in FIG. 9, for e.g. a mask from manufacturer X having the 100% code of “XA,” the pattern-forming area ratio is calculated as 63%, based on the pattern-forming region of the mask having the estimate request number “1020625” (X=102.55, Y=48.00), and the pattern-forming 100% region of the mask from manufacturer X having the 100% code of “XA” (X=110, Y=100). Likewise, for the mask from manufacturer W having the 100% code of “WA,” the pattern-forming area ratio is calculated as 64%.

The unit price is calculated based on the unit price data and the pattern-forming area ratio (S114). Here, as shown in FIG. 9, the mask from manufacturer X having the 100% code of “XA” and the mask from manufacturer W having the 100% code of “WA” that correspond to the estimate request number “1020625” have pattern-forming area ratios of 63% and 64% respectively. Based on these pattern-forming area ratios and the unit price data shown in FIG. 6, a unit price of 800,000 yen corresponding to the pattern-forming area ratio of 60-80% for the mask from manufacturer X having the 100% code of “XA” and a unit price of 600,000 yen corresponding to the pattern-forming area ratio of 40-65% for the mask from manufacturer W having the 100% code of “WA” are selected. As a result, as shown in FIG. 9, for the estimate request number of “1020625,” the unit price is calculated as 800,000 yen for the 100% code of “XA” and as 600,000 yen for the 100% code of “WA.”

A mask manufacturer to which an order is sent is determined based on the calculated unit price. Here, for example, mask manufacturer W with the 100% code of “WA” that has the lower unit price is selected, as shown in FIG. 9.

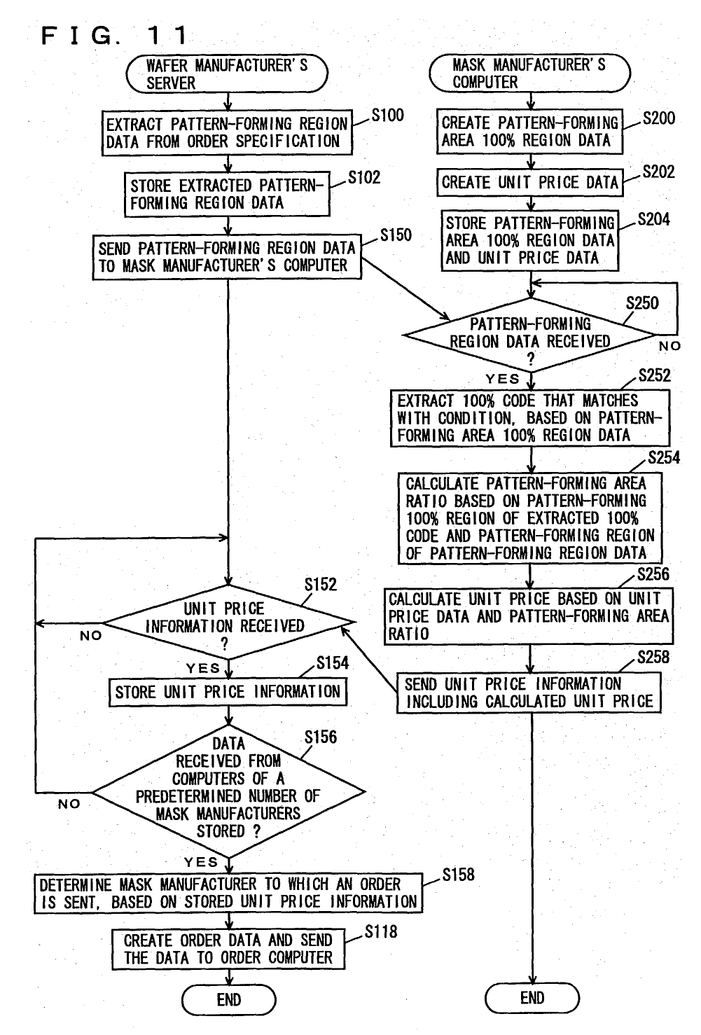

Moreover, a similar process is performed for the estimate request number of “1020626” in FIG. 7, and the result of the calculated unit price is shown in FIG. 10. Here, manufacturer Z having the lowest unit price for the estimate request number of “1020626” is selected as a mask manufacturer to which an order is sent.

As described above, using the mask manufacturer selecting system according to the present embodiment, the pattern-forming area ratio is calculated based on the area corresponding to 100% of a mask pattern and an actual area of a photomask pattern included in an order specification. Based on the pattern-forming area ratio and a unit price determined in advance, an estimated price is calculated. For instance, a unit price is set higher as the pattern-forming area ratio increases, and lower as the pattern-forming area ratio decreases. Hence, as the area of the photomask pattern to which an actual order is sent becomes smaller relative to the 100% area, a lower estimated price can be calculated. Thus, the estimated price may be varied based on the pattern-forming area ratio of the photomask, to select a mask manufacturer.

Modification of First Embodiment

A modification of the mask manufacturer selecting system according to the first embodiment of the present invention will be described below. It is noted that the modification described below has a hardware configuration similar to that of the mask manufacturer selecting system according to the first embodiment described earlier. Therefore, detailed description thereof will not be repeated here.

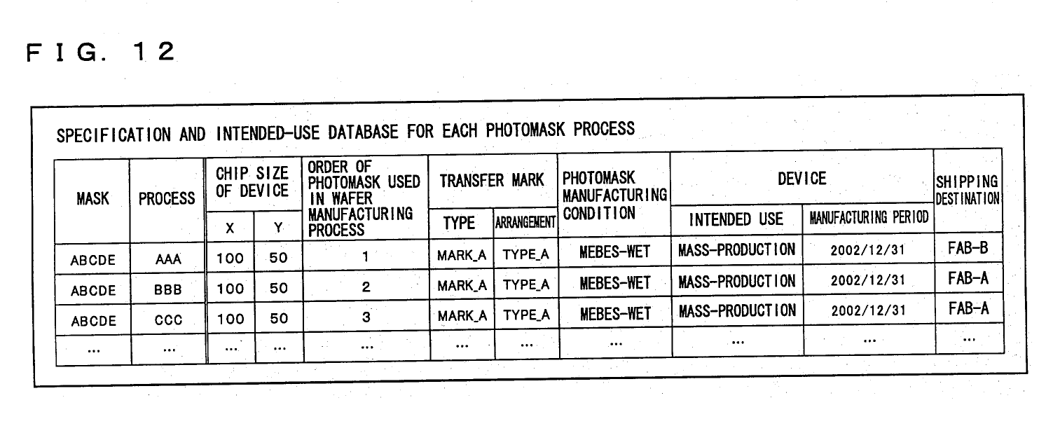

Referring to FIG. 11, the control structure of a program executed in wafer manufacturer's server 100 and mask manufacturer's computer 200 according to the present modification will be described. It is noted that the process steps in the flowchart shown in FIG. 11 similar to those in the flowchart shown in FIG. 8 are denoted by the same step numbers. The processes performed thereat are also the same. Thus, detailed description thereof will not be repeated here.

At S150, CPU 120 of wafer manufacturer's server 100 sends pattern-forming region data to mask manufacturer's computer 200. At S152, CPU 120 determines whether or not unit price information has been received from mask manufacturer's computer 200. If the unit price information has been received (YES at S152), the process goes on to S154. If not (NO at S152), the process goes back to S152, where CPU 120 waits for reception of the unit price information from mask manufacturer's computer 200.

At S154, CPU 120 stores the unit price information into fixed disk 124.

At S156, CPU 120 determines whether or not the unit price information received from computers 200 of a predetermined number of mask manufacturers have been stored. If the unit information received from computers 200 of the predetermined number of mask manufacturers have been stored (YES at S156), the process goes on to S158. If not (NO at S156), the process goes back to S152.

At S158, CPU 120 determines a mask manufacturer to which an order is sent, based on the unit price information stored in fixed disk 120. Here, the mask manufacturer having the lowest unit price is determined as the mask manufacturer to which an order is sent.

At S250, CPU 220 of mask manufacturer's computer 200 determines whether or not the pattern-forming region data has been received from wafer manufacturer's server 100. If the pattern-forming region data has been received from wafer manufacturer's server 100 (YES at S250), the process goes on to S252. If not (NO at S250), the process goes back to S250, where CPU 220 waits for reception of the pattern-forming region data from wafer manufacturer's server 100.

At S252, CPU 220 extracts a 100% code that matches a condition, based on the pattern-forming area 100% region data. At S254, CPU 220 calculates the pattern-forming area ratio based on the pattern-forming 100% region of the extracted 100% code and the pattern-forming region of the pattern-forming region data.

At S256, CPU 220 calculates a unit price based on the unit price data and the pattern-forming area ratio. At S258, CPU 220 sends unit price information including the calculated unit price to wafer manufacturer's server 100.

The operation of the mask manufacturer selecting system according to the present modification based on the above-described structure and flowchart will now be described.

At wafer manufacturer's server 100, pattern-forming region data (FIG. 7) is extracted from an order specification (S100), and the extracted pattern-forming region data is stored into fixed disk 120 (S102). The pattern-forming region data is sent to mask manufacturer's computer 200 (S150), i.e., to computers 200 of a plurality of mask manufacturers.

At mask manufacturer's computer 200, pattern-forming area 100% region data (FIG. 5) is created (S200), and then price data (FIG. 6) is created (S202). The pattern-forming area 100% region data and unit price data are stored into fixed disk 220 of mask manufacturer's computer 200 (S204).

When mask manufacturer's computer 200 receives the pattern-forming region data from wafer manufacturer's server 100 (YES at S250), a 100% code that matches a condition is extracted based on the pattern-forming area 100% region data (S252).

A pattern-forming area ratio is calculated based on the pattern-forming 100% region of the extracted 100% code and the pattern-forming region of the pattern-forming region data (S254).

A unit price is calculated from the pattern-forming area ratio based on the unit price data and the pattern-forming area ratio (S256). Unit price information including the calculated unit price is created and sent to server 100 (S258).

If wafer manufacturer's server 100 receives the unit price information from mask manufacturer's computer 200 (YES at S252), it stores the received unit price information into fixed disk 120 (S254). Such an operation is repeatedly executed until data received from computers 200 of a predetermined number of mask manufacturers are stored. If the unit price information have been received from computers 200 of a predetermined number of mask manufacturers (YES at S156), a mask manufacturer to which an order is sent is determined based on the unit price information (S158).

Thus, in the mask manufacturer selecting system according to the present modification, a pattern-forming area ratio is calculated at a mask manufacturer's computer, and a unit price of a photomask is calculated based on the calculated pattern-forming area ratio, as in the first embodiment described earlier. The calculated unit price is transmitted, as unit price information, from the mask manufacturer's computer to the server, where a mask manufacturer to which an order is sent can be determined based on the unit price information.

Second Embodiment

A mask manufacturer selecting system according to the second embodiment of the present invention will now be described below. It is noted that wafer manufacturer's server 100 and mask manufacturer's computer 200 have the same hardware configuration as those in the first embodiment described earlier, except for the database and flowchart as will be shown below. Therefore, detailed description thereof will not be repeated here.

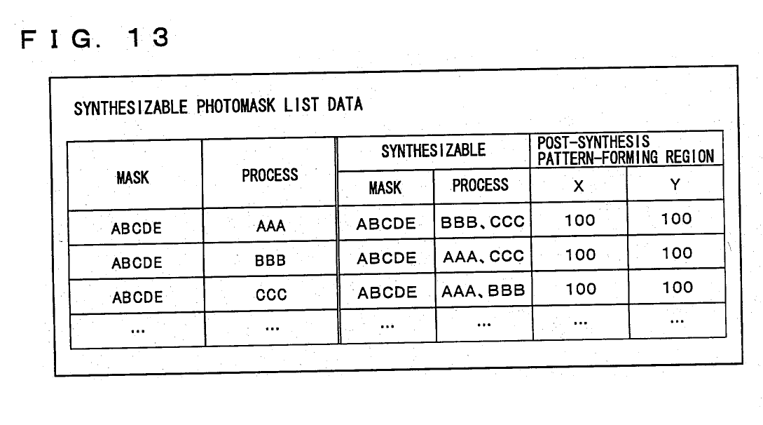

Referring to FIG. 12, a specification and intended-use database for each photomask process that is stored in fixed disk 220 of mask manufacturer's computer 200 will be described. As shown in FIG. 12, the database stores the chip size of a device, the order of a photomask used in the wafer manufacturing process, the type and arrangement of a transfer mark, a manufacturing condition of a photomask, an intended use of the device, a manufacturing period of the device, and a shipping destination.

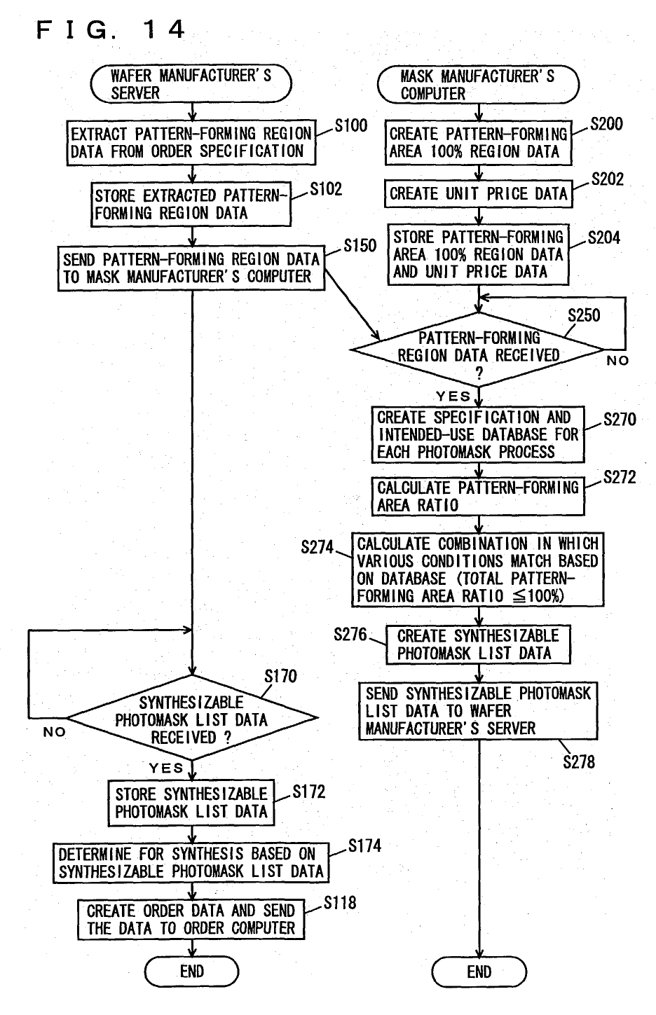

Referring to FIG. 13, synthesizable photomask list data created at mask manufacturer's computer 200 and sent to server 100 will be described. As shown in FIG. 13, the synthesizable photomask list data stores the names of masks and processes that can be synthesized, and a post-synthesis pattern-forming region (X, Y).

Referring to FIG. 14, the control structure of a program executed at wafer manufacturer's server 100 and mask manufacturer's computer 200 of the mask manufacturer selecting system according to the present embodiment will be described. It is noted that the same processes as the ones shown in the flowchart of FIG. 11 described earlier are denoted by the same step numbers. The processes performed thereat are also the same. Therefore, detailed description thereof will not be repeated here.

At S170, CPU 120 of wafer manufacturer's server 100 determines whether or not the synthesizable photomask list data (FIG. 13) has been received from mask manufacturer's computer 200. If the synthesizable photomask list data has been received (YES at S170), the process goes on to S172. If not (NO at S170), the process goes back to S170, and waits for reception of the synthesizable photomask list data from mask manufacturer's computer 200.

At S172, CPU 120 stores the synthesizable photomask list data (FIG. 13) into fixed disk 124.

At S174, CPU 120 determines whether or not synthesis is performed based on the synthesizable photomask list data. Here, determination for synthesis is made based on the content displayed on monitor 104 of wafer manufacturer's server 100 and on information entered by an operator.

At S270, CPU 220 of mask manufacturer's computer 200 creates a specification and intended-use database for each photomask process (FIG. 12). At S272, CPU 220 calculates a pattern-forming area ratio. At S274, CPU 220 calculates a combination that matches various conditions, based on the database. Here, the calculation is performed such that the total pattern-forming area ratio is at most 100%.

At S276, CPU 220 creates the synthesizable photomask list data (FIG. 13). At S278, CPU 220 sends the synthesizable photomask list data (FIG. 13) to wafer manufacturer's server 100.

The operation of the mask manufacturer selecting system according to the present embodiment based on the above-described structure and flowchart will be described.

At wafer manufacturer's server 100, the pattern-forming region data (FIG. 7) is extracted from an order specification (S100) and is stored into fixed disk 120 (S102). The pattern-forming region data (FIG. 7) is sent to mask manufacturer's computer 200 (S150).

At mask manufacturer's computer 200, pattern-forming area 100% region data (FIG. 5) is created (S200) and then the unit price data (FIG. 6) is created (S202). The pattern-forming area 100% region data and unit price data are stored into fixed disk 220 (S204).

If mask manufacturer's computer 200 has received the pattern-forming region data from wafer manufacturer's server 100 (YES at S250), it creates a specification and intended-use database for each photomask process (S270). A pattern-forming area ratio is calculated (S272), and a combination in which various conditions match is calculated based on the database. For instance, as shown in FIG. 12, the processes “BBB” and “CCC” that have the same shipping destination are subject to synthesis. Here, a combination is further set such that the total pattern-forming area ratio of masks is at most 100%.

Mask manufacturer's computer 200 creates the synthesizable photomask list data (FIG. 13) (S276), and sends the data to wafer manufacturer's server 100 (S278).

If wafer manufacturer's server 100 has received synthesizable photomask list data (FIG. 13) (YES at S170), it stores the synthesizable photomask list data into fixed disk 124 (S172). It is determined whether or not photomasks need to be synthesized, based on the synthesizable photomask list data (FIG. 13) (S174).

As has been described above, in the mask selecting system according to the present embodiment, photomasks are synthesized together in a range such that a pattern-forming area ratio does not far exceed 100%, to manufacture a plurality of masks on one substrate. Thus, a unit price of a photomask can be lowered.

Although the present invention has been described and illustrated in detail, it is dearly understood that the same is by way of illustration and example only and is not to be taken by way of limitation, the spirit and scope of the present invention being limited only by the terms of the appended claims.

What is claimed is:

1. A method of selecting a mask manufacturer from at least two mask manufacturers that manufacture photomasks used in manufacturing of a semiconductor wafer, comprising the steps of:
storing a maximum area of a pattern formed on a photomask for each of said at least two mask manufacturers;
storing a price paid by an orderer for manufacturing of said photomask in accordance with a ratio of said maximum area to an area of the pattern formed on the photomask, for each of said at least two mask manufacturers;
storing order specification data including the area of the pattern of said photomask;
calculating a pattern-forming ratio of said maximum area to an area of the pattern of the photomask included in said order specification data, for each of said at least two mask manufacturers;
calculating an estimated price for said order specification data based on said calculated pattern-forming ratio and a price stored in accordance with said stored ratio, for each of said at least two mask manufacturers; and
selecting one mask manufacturer from said at least two mask manufacturers based on at least two of said estimated prices calculated for each of said at least two mask manufacturers.

2. The method of selecting a mask manufacturer according to claim 1, further comprising the step of receiving a price corresponding to said maximum area and said ratio from said mask manufacturer.

3. The method of selecting a mask manufacturer according to claim 1, further comprising the step of sending said calculated estimated price for each mask manufacturer to said orderer.

4. The method of selecting a mask manufacturer according to claim 1, further comprising the step of creating order data for said selected one mask manufacturer.

5. The method of selecting a mask manufacturer according to claim 1, further comprising the step of sending said created order data to said mask manufacturer.

6. A method of selecting a mask manufacturer from at least two mask manufacturers that manufacture photomasks used in manufacturing of a semiconductor wafer, comprising the steps of:
storing a maximum area of a pattern formed on a photomask for each of said at least two mask manufacturers;
storing order specification data including areas of a plurality of patterns for said photomask;
calculating a pattern-forming ratio of said maximum area to an area of a pattern of a photomask included in said order specification data for each of said at least two mask manufacturers;
creating synthesizable pattern information for a combination of said plurality of patterns such that a pattern-forming ratio of the combined patterns satisfies a predetermined condition, for each of at least two mask manufacturers; and
selecting one mask manufacturer from said at least two mask manufacturers based on the synthesizable pattern information created for each of said at least two mask manufacturers.

7. The method of selecting a mask manufacturer according to claim 6, further comprising the step of receiving said maximum area from said mask manufacturer.

8. The method of selecting a mask manufacturer according to claim 6, further comprising the step of sending said synthesizable pattern information created for each mask manufacturer to said orderer.

9. The method of selecting a mask manufacturer according to claim 6, further comprising the step of creating order data for said selected one mask manufacturer.

10. The method of selecting a mask manufacturer according to claim 6, further comprising the step of sending said created order data to said mask manufacturer.
